(19) United States
(12) Patent Application Publication
(10) Pub. No.: US 2026/0218801 A1
(43) Pub. Date: Jul. 30, 2026

(54) VALVE APPARATUS, INTEGRATED ASSEMBLY, AND VALVE APPARATUS MANUFACTURING METHOD

(71) Applicant: ZHEJIANG SANHUA AUTOMOTIVE COMPONENTS CO., LTD., Hangzhou, Zhejiang (CN)

(72) Inventors: Jundong WANG, Hangzhou, Zhejiang (CN); Shengzhou YIN, Hangzhou, Zhejiang (CN); Haitao CHEN, Hangzhou, Zhejiang (CN)

(73) Assignee: ZHEJIANG SANHUA AUTOMOTIVE COMPONENTS CO., LTD., Hangzhou, Zhejiang (CN)

(21) Appl. No.: 19/146,894

(22) PCT Filed: Jan. 9, 2024
(86) PCT No.: PCT/CN2024/071315

§ 371 Date: Jul. 9, 2025

(30) Foreign Application Priority Data
Jan. 9, 2023 (CN) 202310025498.6
Jan. 9, 2023 (CN) 202310025784.2
Jan. 9, 2023 (CN) 202310762326.7

(51) Int. Cl. F16K 11/085; F16K 11/087

(52) U.S. Cl. CPC F16K 11/0853; F16K 11/0876

(57) ABSTRACT

A valve apparatus, an integrated assembly, and a valve apparatus manufacturing method are provided. The valve apparatus includes a first housing. The first housing includes an inner side wall, at least part of which faces a valve core along the radial direction of the valve apparatus, a first sealing member is fixedly connected to the inner side wall, the first housing has a first communicating opening, at least part of the first sealing member surrounds the first communicating opening, and a communicating channel is communicated with the first communicating opening; and/or the first housing includes an outer side wall, a first valve body includes a second sealing member, which is fixedly connected to the outer side wall, the first housing has a second communicating opening, at least part of the second sealing member surrounds the second communicating opening, and a communicating channel is communicated with the second communicating opening.

The present application claims the priorities to following Chinese Patent Applications, which are incorporated herein by reference in there entireties: Chinese Patent Application No. 202310025498.6, titled “VALVE APPARATUS AND INTEGRATED ASSEMBLY”, filed on Jan. 9, 2023; Chinese Patent Application No. 202310025784.2, titled “VALVE APPARATUS AND MANUFACTURING METHOD THEREOF”, filed on Jan. 9, 2023; and Chinese Patent Application No. 202310762326.7, titled “VALVE APPARATUS AND INTEGRATED ASSEMBLY”, filed on Jan. 9, 2023.

### FIELD

The present application relates to the technical field of fluid control, and in particular to a valve apparatus, an integrated assembly, and a method for manufacturing the valve apparatus.

### BACKGROUND

A valve apparatus can be applied to a fluid system to control opening or closing of a fluid channel or flow direction change.

In the related technology, the valve apparatus can be mounted to a mounting block having a fluid channel. At least a portion of the valve apparatus is configured to be inserted into a mounting cavity of the mounting block, and this portion is sealed against a wall forming the mounting cavity via a sealing member. If the sealing member and the valve apparatus are separate structures, there is a risk that the sealing member is displaced relative to the valve apparatus or detached from the valve apparatus.

In some other related technologies, the valve apparatus generally includes a valve body, a valve core and a sealing member. At least a portion of the valve core and the sealing member are located in an inner cavity of the valve body, and the sealing member is located between the valve body and the valve core. In these related technologies, the sealing member and the valve body are separate structures. During the assembling process of the valve apparatus, the sealing member and the valve core need to be placed into the inner cavity separately, posing a risk that the sealing member is displaced relative to the valve body or detached from the valve body.

### SUMMARY

An object of the present application is to provide a valve apparatus, an integrated assembly, and a method for manufacturing the valve apparatus, which can reduce the risk that a sealing member is displaced relative to a valve body or detached from a valve body.

A valve apparatus includes a valve body assembly and a valve core. At least a portion of the valve core is located in an accommodation cavity of the valve body assembly. The valve core has a communication channel. The valve body assembly includes a first housing. The first housing includes an inner side wall, at least a portion of the inner side wall faces the valve core, a first sealing member is fixedly connected to the inner side wall, the first housing has a first communication opening, at least a portion of the first sealing member surrounds the first communication opening, and the communication channel is allowed to be in communication with the first communication opening; and/or, the first housing includes an outer side wall, the first valve body includes a second sealing member, which is fixedly connected to the outer side wall, the first housing has a second communication opening, at least a portion of the second sealing member surrounds the second communication opening, and the communication channel is allowed to be in communication with the second communication opening.

In the valve apparatus provided according to an embodiment of the present application, the first sealing member is fixedly connected to an inner side wall of a first housing, thereby the risk that the first sealing member is displaced relative to the first housing or detached from the first housing can be reduced; and/or, the second sealing member is fixedly connected to an outer side wall of the first housing, thereby the risk that the second sealing member is displaced relative to the first housing or detached from the first housing can be reduced.

An integrated assembly is further provided according to an embodiment of the present application, including a communication assembly and the valve apparatus described above. The communication assembly includes a first flow channel, a second flow channel and a mounting cavity, and at least a portion of the valve body assembly is located in the mounting cavity. The first flow channel is in communication with the first communication opening, and the second flow channel is in communication with the second communication opening. In a radial direction of the valve body assembly, the second sealing member is located between a wall forming the mounting cavity and the outer side wall. The wall forming the mounting cavity abuts against the second sealing member, and the outer side wall abuts against the second sealing member.

In the integrated assembly provided according to an embodiment of the present application, the second sealing member is located between a wall forming the mounting cavity and the outer side wall in the radial direction of the valve body assembly, and the second sealing member is fixedly connected to the outer side wall, thereby the risk that the second sealing member is detached from the valve body assembly or displaced relative to the valve body assembly when assembling the valve apparatus and the communication assembly can be reduced.

A method for manufacturing a valve apparatus is further provided according to an embodiment of the present application, including the following steps: fixedly connecting a first sealing member to an inner side wall of a first housing to form at least a portion of a first valve body; and fixedly or limitedly connecting the first valve body to a second valve body to form a valve body assembly.

In the method for manufacturing the valve apparatus provided according to an embodiment of the present application, fixedly connecting a first sealing member to an inner side wall of a first housing reducing the risk that the first sealing member is displaced relative to the first housing or detached from the first housing.

### BRIEF DESCRIPTION OF THE DRAWINGS

FIG. 1 is a schematic perspective view of a valve apparatus according to an embodiment of the present application;

FIG. 2 is a schematic exploded view of the valve apparatus shown in FIG. 1;

FIG. 3 is a schematic side view of the valve apparatus shown in FIG. 1;

FIG. 4 is a schematic cross-sectional view of the valve apparatus shown in FIG. 3 taken along line A-A;

FIG. 5 is a schematic perspective cross-sectional view of the valve apparatus shown in FIG. 4 taken along line B-B;

FIG. 6 is a schematic perspective view of a first valve body of the valve apparatus shown in FIG. 4;

FIG. 7 is a schematic cross-sectional view of a first valve body of the valve apparatus shown in FIG. 4;

FIG. 8 is a schematic partial enlarged view of part X of the first valve body shown in FIG. 7;

FIG. 9 is a schematic perspective view of a first housing;

FIG. 10 is a schematic perspective view of a second cover;

FIG. 11 is a schematic perspective view of a portion of a second valve body;

FIG. 12 is a schematic cross-sectional view of a portion of an integrated assembly according to an embodiment of the present application;

FIG. 13 is a schematic exploded view of the integrated assembly shown in FIG. 12;

FIG. 14 is a schematic view showing assembly steps of a valve apparatus according to an embodiment of the present application;

FIG. 15 is a flowchart of a method for manufacturing a valve apparatus according to an embodiment of the present application;

FIG. 16 is a flowchart of a method for manufacturing a valve apparatus according to another embodiment of the present application;

FIG. 17 is a schematic perspective view of a valve apparatus according to another embodiment of the present application;

FIG. 18 is a schematic exploded view of the valve apparatus shown in FIG. 17;

FIG. 19 is a schematic side view of the valve apparatus shown in FIG. 17;

FIG. 20 is a schematic cross-sectional view of the valve apparatus shown in FIG. 19 taken along line C-C;

FIG. 21 is a schematic perspective view of a valve apparatus according to yet another embodiment the present application;

FIG. 22 is a schematic exploded view of the valve apparatus shown in FIG. 21;

FIG. 23 is a schematic partial cross-sectional view of a first valve body and a sealing seat of a valve apparatus according to yet another embodiment the present application;

FIG. 24 is a schematic perspective view of a valve apparatus according to yet another embodiment the present application;

FIG. 25 is a schematic exploded view of the valve apparatus shown in FIG. 24;

FIG. 26 is a schematic perspective view of a portion of the valve apparatus shown in FIG. 24;

FIG. 27 is a schematic perspective view of a valve apparatus according to yet another embodiment of the present application;

FIG. 28 is a schematic exploded view of the valve apparatus shown in FIG. 27;

FIG. 29 is a schematic side view of the valve apparatus shown in FIG. 27;

FIG. 30 is a schematic cross-sectional view of the valve apparatus shown in FIG. 29 taken along line D-D;

FIG. 31 is a schematic perspective cross-sectional view of the valve apparatus shown in FIG. 30 taken along line E-E;

FIG. 32 is a schematic cross-sectional view of a portion of the valve apparatus shown in FIG. 30;

FIG. 33 is a schematic partial enlarged view of part Y of the valve apparatus shown in FIG. 32;

FIG. 34 is a schematic partial cross-sectional view of a valve apparatus according to another embodiment the present application;

FIG. 35 is a schematic partial cross-sectional view of a valve apparatus according to still another embodiment of the present application;

FIG. 36 is a schematic cross-sectional view of a portion of an integrated assembly according to an embodiment of the present application;

FIG. 37 is a schematic exploded view of the integrated assembly shown in FIG. 36;

FIG. 38 is a perspective schematic view of a valve apparatus according to yet another embodiment of the present application;

FIG. 39 is a schematic exploded view of a portion of the valve apparatus shown in FIG. 38;

FIG. 40 is a schematic cross-sectional view of the valve apparatus shown in FIG. 38;

FIG. 41 is a schematic perspective cross-sectional view of the valve apparatus shown in FIG. 40 taken along line F-F;

FIG. 42 is a schematic perspective view of a valve apparatus according to still another embodiment of the present application;

FIG. 43 is a schematic exploded view of a portion of the valve apparatus shown in FIG. 42;

FIG. 44 is a schematic perspective cross-sectional view of the valve apparatus shown in FIG. 42.

Reference numerals are explained as follows:

| | |
|---|---|
| 10 valve body assembly; | 30 accommodation cavity; |
| 301 notch channel; | 1 first cover; |
| 11 first recess; | 111 first limiting wall; |
| 12 first hole; | 13 third recess; |
| 131 third limiting wall; | 112 first bottom wall; |
| 2 second cover; | 21 second recess; |
| 211 second limiting wall; | 22 second hole; |
| 23 fourth recess; | 231 fourth limiting wall; |
| 212 second bottom wall; | 31 first valve body; |
| 311 first housing; | 312 inner side wall; |
| 313 outer side wall; | 314 first communication opening; |
| 33 first channel; | 34 second channel; |
| 35 second communication opening; | 322 second through-hole; |
| 32 second valve body; | 36 third communication opening; |
| 4 sealing seat; | 41 through-hole; |
| 51 second sealing member; | 521 connecting part; |
| 522 sealing part; | 515 first through-hole; |
| 516 third through-hole; | 52 first sealing member; |
| 523 coupling part; | 53 third sealing member; |
| 6 communication assembly; | 61 first flow channel; |
| 62 second flow channel; | 63 mounting cavity; |
| 7 valve core; | 71 communication channel; |
| 8 driving part; | 81 stator assembly; |
| 811 coil; | 82 rotor assembly; |
| 9 transmission assembly. | |

### DETAILED DESCRIPTION OF THE EMBODIMENTS

The embodiments will be described in detail below with reference to the accompanying drawings.

In order to make the objects, technical solutions, and advantages of the present application more clear, the present application will be further described in detail below in conjunction with the accompanying drawings and specific embodiments. In this specification, relationship terms such as “first” and “second” are only used to distinguish one component having the same name from another component, but do not necessarily require or imply that any such actual relationship or sequence exists between these components.

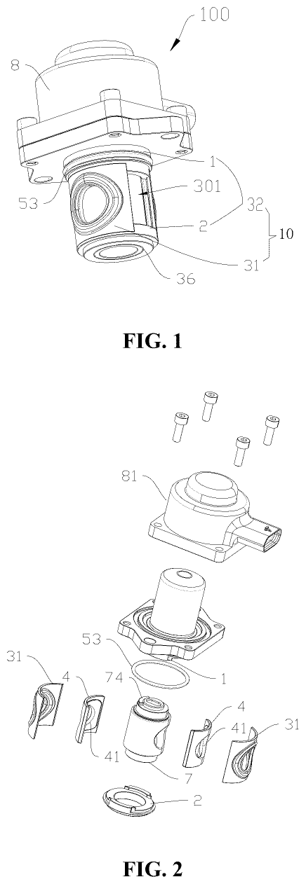

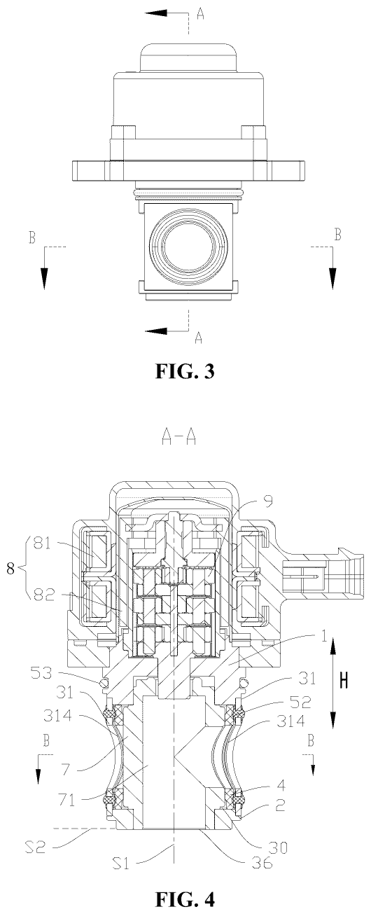

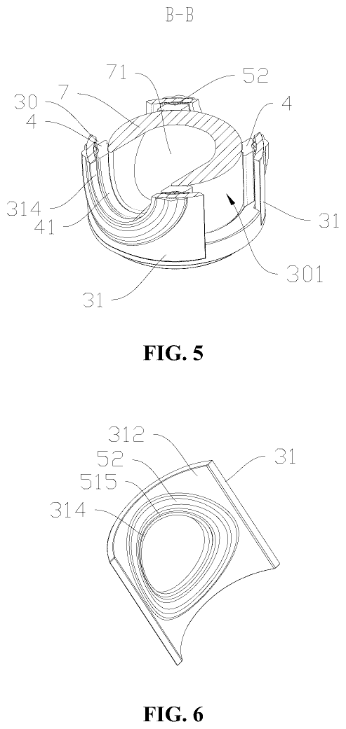

As shown in FIG. 1 to FIG. 11, a valve apparatus 100 includes a valve body assembly 10, a valve core 7, a transmission assembly 9, and a driving part 8. The driving part 8 includes a rotor assembly 82 and a stator assembly 81, and at least a portion of the valve core 7 is located in an accommodation cavity 30 of the valve body assembly 10. The rotor assembly 82 is in transmission connection with the transmission assembly 9, and the valve core 7 is in transmission connection with the transmission assembly 9 and is rotatable under the driving of the transmission assembly 9. The stator assembly 81 may be electrically connected and/or signally connected to the outside, at least a portion of the stator assembly 81 is located outside of the rotor assembly 82, and the transmission assembly 9 is a planetary gear mechanism.

As shown in FIG. 4, an axial direction of the valve apparatus 100 is defined and shown by H in the figure. A central axis of the valve core 7 is defined, the valve core 7 is rotatable around the central axis, and the central axis of the valve core 7 is shown by S1 in FIG. 4. The axial direction of the valve apparatus 100 is the same as an extension direction of the central axis of the valve core 7.

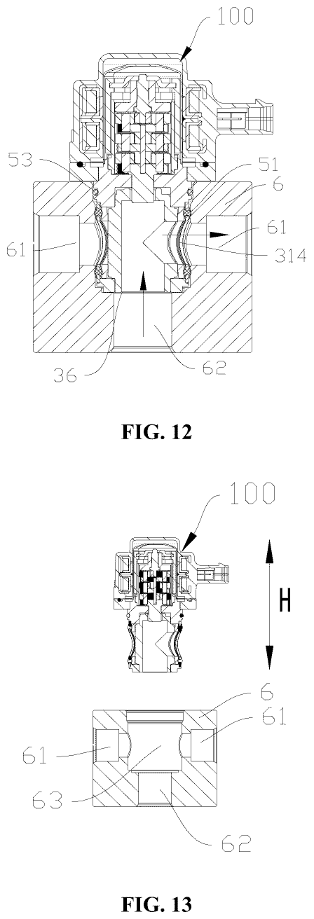

FIG. 12 and FIG. 13 show an integrated assembly including the valve apparatus 100. The integrated assembly further includes a communication assembly 6, which may be plate-shaped or block-shaped, and only a portion of the communication assembly 6 is shown in FIG. 12. The communication assembly 6 has a mounting cavity 63, and at least a portion of the valve body assembly 10 is located in the mounting cavity 63 when the valve apparatus 100 is mounted to the communication assembly 6. When assembling the integrated assembly, at least a portion of the valve body assembly 10 is inserted into the mounting cavity 63 along the axial direction of the valve apparatus 100.

As shown in FIG. 4 to FIG. 9, the valve body assembly 10 includes a first valve body 31 and a second valve body 32 arranged separately. The first valve body 31 includes a first housing 311 and a first sealing member 52. The first housing 311 includes an inner side wall 312, and at least a portion of the inner side wall 312 faces the valve core 7 in a radial direction of the valve apparatus 100.

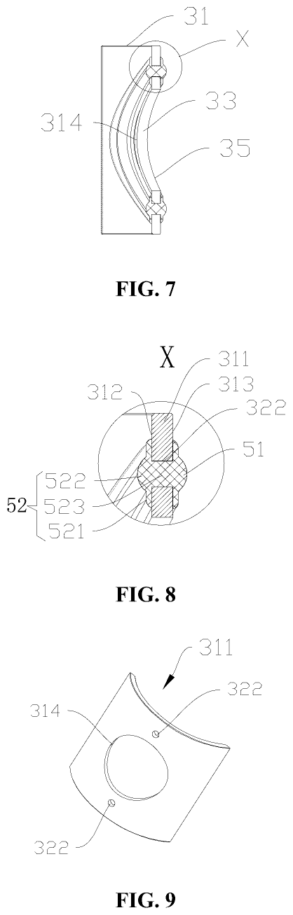

As shown in FIG. 8, the first housing 311 includes an outer side wall 313, and the inner side wall 312 and the outer side wall 313 are located on two opposite sides of the first housing 311 in the radial direction of the valve apparatus 100. As shown in FIG. 6, FIG. 7 and FIG. 8, the first housing 311 has a second communication opening 35, which is located on the outer side wall 313 and is in communication with a first communication opening 314. Specifically, the first housing 311 has a first channel 33, through which the first communication opening 314 is in communication with the second communication opening 35.

As shown in FIG. 4 to FIG. 8, the first sealing member 52 has a first through-hole 515, which corresponds to and is in communication with the first communication opening 314, that is, at least a portion of the first communication opening 314 faces the first through-hole 515. Specifically, at least a portion of the first sealing member 52 surrounds the first communication opening 314, so that the first sealing member 52 can reduce the internal leakage of the valve apparatus 100. The valve core 7 has a communication channel 71, which can be in communication with the first communication opening 314 through the rotation of the valve core 7. The valve apparatus 100 further has a third communication opening 36, which is in communication with the communication channel 71. It should be noted that the “surrounding” in the present application includes, but is not limited to, a circular shape, and also includes other shapes that are connected end to end and can enclose a closed area, such as a rectangle, an ellipse, and the like, and the shape is not limited to being parallel to a certain plane, or may be curved in multiple directions. In summary, any first sealing member 52 located around the first communication opening 314 and separating the first communication opening 314 from other flow channels is within the protection scope of “surrounding” in the present application, and the “surrounding” in the following description is the same.

As shown in FIG. 2 and FIG. 4, the valve apparatus 100 includes a sealing seat 4, and at least a portion of the sealing seat 4 is located between the first sealing member 52 and an outer periphery of the valve core 7 in the radial direction of the valve apparatus 100. One side of the sealing seat 4 is in sliding fit with the outer periphery of the valve core 7, and the other side of the sealing seat 4 abuts against or is fixedly connected to the first sealing member 52. The sealing seat 4 has a through-hole 41, which is in communication with the first communication opening 314. The through-hole 41 may be in communication with the communication channel 71. The first sealing member 52 is an elastic member, which has a certain amount of compression in the radial direction of the valve apparatus 100. A force directed towards the valve core 7 is applied to the sealing seat 4 by the first sealing member 52, so that the sealing seat 4 is attached to the valve core 7, and the first sealing member 52 may play a compensation role.

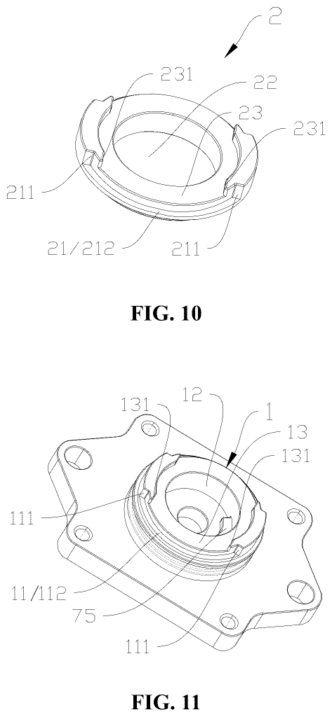

As shown in FIG. 4, FIG. 10 and FIG. 11, in this embodiment, the second valve body 32 includes a first cover 1 and a second cover 2, which are separated by a certain distance in the axial direction of the valve apparatus 100. The first cover 1 and the second cover 2 are located on two sides of the first housing 311, at least a portion of the valve core 7 is located between the first cover 1 and the second cover 2, and the first cover 1 is arranged closer to the driving part 8 than the second cover 2. The first cover 1 has a first hole 12, and the second cover 2 has a second hole 22. The first hole 12 is coaxially arranged with the second hole 22. A portion of the valve core 7 is located in the first hole 12 and is in sliding fit with a wall forming the first hole 12, and a portion of the valve core 7 is located in the second hole 22 and is in sliding fit with a wall forming the second hole 22. That is, the first hole 12 and the second hole 22 radially limit the valve core 7 so as to improve the centering of the valve core 7, and the first cover 1 and the second cover 2 act like bearings. Along the axial direction of the valve apparatus 100, one end of the first housing 311 is fixedly connected to the first cover 1, and the other end of the first housing 311 is fixedly connected to the second cover 2, for example, by welding, which provides a more secure fixation.

In this embodiment, the first cover 1 and the second cover 2 are both made of metal materials. The first cover 1 includes a first recess 11, and the second cover 2 includes a second recess 21, with the first recess 11 and the second recess 21 being at least partially aligned with each other in the axial direction of the valve apparatus 100. Along a circumferential direction of the valve apparatus 100, each end of the first recess 11 includes a first limiting wall 111, and each end of the second recess 21 includes a second limiting wall 211. Along the axial direction of the valve apparatus, one end of the first housing 311 is located in a groove of the first recess 11, and the other end of the first housing 311 is located in a groove of the second recess 21, thereby limiting the first housing 311. Specifically, two ends of the first housing 311 in the circumferential direction of the valve apparatus abut against the first limiting walls 111 or are arranged with a gap to the first limiting walls 111, and two ends of the first housing 311 in the circumferential direction of the valve apparatus abut against the second limiting walls 211 or are arranged with a gap to the second limiting walls 211, so that the first housing 311 is limited in the circumferential direction of the valve apparatus 100. The first recess 11 has a first bottom wall 112, and the second recess 21 has a second bottom wall 212, with the first bottom wall 112 and the second bottom wall 212 being at least partially aligned with each other. Along the axial direction of the valve apparatus 100, one end of the first housing 311 abuts against the first bottom wall 112 or is arranged with a gap to the first bottom wall 112, and the other end of the first housing 311 abuts against the second bottom wall 212 or is arranged with a gap to the second bottom wall 212, so that the first housing 311 is limited in the axial direction of the valve apparatus 100. Along the axial direction of the valve apparatus 100, one end of the first housing 311 is fixed to the first cover 1 by welding, and the other end of the first housing 311 is fixed to the second cover 2 by welding. In other embodiments, the first valve body 31 can be in limiting connection with the second valve body 32. It should be noted that the “limiting connection” in the present application includes a hinge, a clamping connection, and the like. The “fixed connection” in the present application includes threaded connection, welding, bonding, vulcanization fixation, riveting, insert injection molding, interference fit, and the like. In another embodiment of the valve apparatus, the first valve body 31 may be in the form of a sealing cover, the first valve body 31 may be inserted into the second valve body 32 in the radial direction, and the first valve body 31 may be screwed with the second valve body 32.

In this embodiment, the outer periphery of the valve core 7 is cylindrical or quasi-cylindrical in shape, which helps reduce the radial size of the valve core 7, and thereby reduce the radial size of the valve apparatus 100. In addition, compared with a spherical valve core 7, the valve core 7 with the outer peripheral surface being cylindrical in shape is easier to process, and the communication channel 71 inside the valve core 7 may have a relatively large diameter. Under the same diameter, the cylindrical valve core 7 has a lighter weight and requires less material. In this embodiment, the inner side wall 312 extends in the axial direction of the valve apparatus 100, and the inner side wall 312 is cylindrical or quasi-cylindrical in shape and is parallel or substantially parallel to the outer periphery of the valve core 7, so that the radial size of the valve apparatus 100 can be reduced. “Substantially parallel” means that an angle between the two is less than 5 degrees.

Along the radial direction of the valve apparatus 100, the first sealing member 52 is located between the inner side wall 312 and the valve core 7. A first plane is defined and shown by S2 in FIG. 4. The first plane is perpendicular to the axial direction of the valve apparatus 100, and coincides with one end of the valve body assembly 10 in the axial direction. An orthographic projection of the first sealing member 52 on the first plane is parallel or substantially parallel to the inner side wall 312. Alternatively, the curvature of the first sealing member 52 conforms to the shape of the inner side wall 312. This arrangement can reduce the size of the first sealing member 52 in the radial direction of the valve apparatus 100, and in turn reduce the radial size of the valve apparatus 100, thereby facilitating the miniaturization of the valve apparatus 100. In this embodiment, the orthographic projection of the first sealing member 52 on the first plane has an arc shape as a whole.

In this embodiment, the first sealing member 52 is fixedly connected to and is sealed against the inner side wall 312. Specifically, the first sealing member 52 is fixedly connected to or integrated with the inner side wall 312, so that the number of parts of the valve apparatus 100 can be reduced, and the manufacturing steps of the valve apparatus 100 can be simplified. It should be noted that the “fixed connection” in the present application includes a non-detachable connection, such as, welding, riveting, bonding, vulcanization connection, or the like.

The first sealing member 52 is formed and fixed to the inner side wall 312 by a vulcanization process, which can improve the sealing between the first sealing member 52 and the first housing 311. Moreover, the first sealing member 52 can be integrally formed with the first housing 311, thereby facilitate manufacturing. Specifically, the first housing 311 is made of a metal material, such as stainless steel, and the first sealing member 52 is made of rubber, such as EPDM (Ethylene Propylene Diene Monomer). Due to the high surface energy of the metal, the firmness degree after vulcanization can be improved, so that the first sealing member 52 can be firmly fixed to the inner side wall 312 of the first housing 311, thereby reducing the risk of leakage. In other embodiments, after the first sealing member 52 is formed, the first sealing member 52 may fixed to the first housing 311 by adhesive.

As shown in FIG. 7 and FIG. 8, the first sealing member 52 includes a connecting part 521 and a sealing part 522. The connecting part 521 is fixedly connected to the first housing 311, and the sealing part 522 protrudes in a direction away from the inner side wall 312 relative to the connecting part 521 and surrounds the first through-hole 515 along a circumferential direction of the first through-hole 515 to form a closed loop. In a cross-section of the first sealing member 52, the connecting part 521 has a length greater than that of the sealing part 522 in a direction parallel to the inner side wall 312, so that the area of the fixation between the first sealing member 52 and the inner side wall 312 is relatively large, and the firmness of the fixation between the first sealing member 52 and the inner side wall 312 is improved, thereby reducing the risk of leakage between the first sealing member 52 and the inner side wall 312. The sealing part 522 has a relatively small length, so that the sealing part 522 is more easily compressed and deformed in the radial direction of the valve apparatus 100. Specifically, the length of the connecting part 521 may be 1.5 or more times greater than that of the sealing part 522, and the sealing part 522 has an arc-shaped surface.

As shown in FIG. 2 and FIG. 11, an end portion of the valve core 7 includes a limiting boss 74, and the first cover 1 includes a limiting block 75. The limiting boss 74 is cooperated with the limiting block 75, so that a rotation range of the valve core 7 can be limited, and initialization of the valve apparatus 100 in a control process is also facilitated.

In some embodiments of the present application, as shown in FIG. 7 to FIG. 9, the first valve body 31 includes a second sealing member 51. The first housing 311 includes an outer side wall 313, and the inner side wall 312 and the outer side wall 313 are located on two opposite sides of the first housing 311 in the radial direction of the valve apparatus 100. The second sealing member 51 is fixedly connected to or integrated with the outer side wall 313, and at least a portion of the second sealing member 51 surrounds the second communication opening 35, so that the second sealing member 51 can prevent the second communication opening 35 from being in fluid communication with the third communication opening 36 outside the valve apparatus 100. The second sealing member 51 may be formed and fixed to the first housing 311 by a vulcanization process, so that the first sealing member 52 and the second sealing member 51 may be formed at one time in the process of manufacturing the first valve body 31, thereby simplifying the manufacturing steps. The first housing 311 has second through-holes 322, and each of the second through-holes 322 has openings on the inner side wall 312 and the outer side wall 313 of the first housing 311 respectively. The first sealing member 52 includes a coupling part 523, which is located in the second through-hole 322. An end of the coupling part 523 is fixedly connected to or integrated with the second sealing member 51, so that the risk that the first sealing member 52 and the second sealing member 51 are detached from the first housing 311 can be reduced.

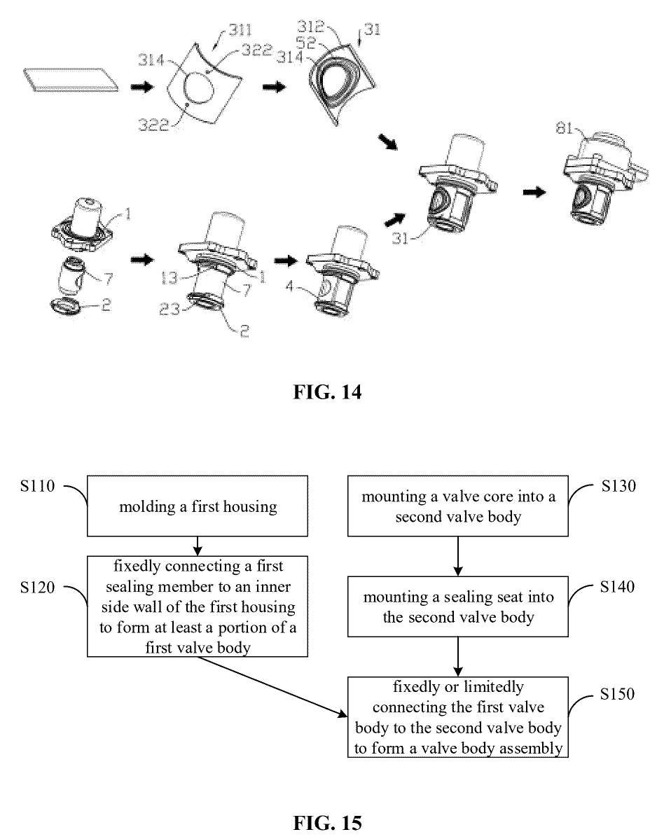

As shown in FIG. 14 and FIG. 15, the method for manufacturing the valve apparatus 100 includes the following steps.

S110, molding a first housing 311.

In this embodiment, an inner side wall 312 of the first housing 311 is cylindrical or quasi-cylindrical in shape, and an outer side wall 313 of the first housing 311 is also cylindrical or cylindrical in shape, with the inner side wall 312 being parallel or substantially parallel to the outer side wall 313. The first housing 311 is in a curved plate shape, and the first housing 311 is made of a metal material. Therefore, molding the first housing 311 includes molding the first housing 311 from a plate by a stamping process. This can simplify the manufacturing process and reduce the cost. In other embodiments, the first housing 311 may be made of a plastic material, and the first housing 311 may be manufactured by injection molding or the like.

S120, fixedly connecting a first sealing member 52 to the inner side wall 312 of the first housing 311 to form at least a portion of a first valve body 31.

In this embodiment, the first sealing member 52 is made of rubber, and fixedly connecting the first sealing member 52 to the inner side wall 312 of the first housing 311 includes fixedly connecting the first sealing member 52 to the inner side wall 312 of the first housing 311 through a vulcanization process.

Further, fixedly connecting the first sealing member 52 to the inner side wall 312 through a vulcanization process includes the following steps:
coating adhesive on the inner side wall 312;
placing at least a portion of the first housing 311 into an inner cavity of a mold, and then injecting a sealing member solution into the inner cavity of the mold; and
heating and pressurizing the sealing member solution and the first housing 311, so that the first sealing member 52 is vulcanized and formed, and is fixedly connected to the inner side wall 312 of the first housing 311.

In this embodiment, the second sealing member 51 and the first sealing member 52 are made of the same material, and in the above vulcanization process, the second sealing member 51 may be formed and fixedly connected to the outer side wall 313 of the first housing 311 by the vulcanization process. That is, the first housing 311 serves as an insert, and the sealing members on both sides of the first housing 311 are simultaneously vulcanized, formed and fixed to the first housing 311, which may further simplify the manufacturing process and reduce the cost. Specifically, fixing the first sealing member 52 to the inner side wall 312 through the vulcanization process includes the following steps: coating adhesive on the inner side wall 312 and the outer side wall 313 of the first housing 311 respectively; placing at least a portion of the first housing 311 in an inner cavity of a mold, and then injecting a sealing member solution into the inner cavity of the mold; and heating and pressurizing the sealing member solution and the first housing 311, so that the first sealing member 52 and the second sealing member 51 are vulcanized and formed, the first sealing member 52 is fixedly connected to the inner side wall 312, and the second sealing member 51 is fixedly connected to the outer side wall 313. The second through-hole 322 of the first housing 311 may allow the sealing member solution to pass through during the injection process, so that the sealing member solution may be better distributed on two sides of the first housing 311.

Compared with the entire annular valve body, the first valve bodies 31 are separately arranged. In the circumferential direction of the valve apparatus 100, an included angle between two planes extending respectively through two ends of the first housing 311 and intersecting at the central axis of the valve core 7 is less than 180 degrees, so that both radial sides of the first valve body 31 are not closed, thereby facilitating the vulcanization and demolding of the sealing members on both sides of the first housing 311, especially the vulcanization and demolding of the first sealing member 52 fixed to the inner side wall 312. For example, the mold may be removed along the radial direction of the first valve body 31.

S130, mounting a valve core 7 into the second valve body 32.

In this embodiment, the second valve body 32 includes a first cover 1 and a second cover 2. Therefore, mounting the valve core 7 into the second valve body 32 includes inserting a portion of the valve core 7 into a first hole 12 of the first cover 1, and inserting a portion of the valve core 7 into a second hole 22 of the second cover 2. In other embodiments, the second valve body 32 may have an integral structure.

S140, mounting a sealing seat 4 into the second valve body 32.

In this embodiment, the first cover 1 includes a third recess 13, the second cover 2 includes a fourth recess 23, and the third recess 13 and the fourth recess 23 are at least partially aligned with each other in the axial direction of the valve apparatus 100. Along a circumferential direction of the valve apparatus 100, each end of the third recess 13 includes a third limiting wall 131, and each end of the fourth recess 23 includes a fourth limiting wall 231. Therefore, mounting the sealing seat 4 to the second valve body 32 includes limiting a portion of the sealing seat 4 in a groove of the third recess 13, and limiting a portion of the sealing seat 4 in a groove of the fourth recess 23. Therefore, the sealing seat 4 is limited by the second valve body 32 in the circumferential direction, and the sealing seat 4 will not be displaced relative to the first valve body 31 during subsequent manufacturing and use. In addition, the sealing seat 4 can be mounted into the second valve body 32 in the radial direction of the valve apparatus 100.

S150, fixedly or limitedly connecting the first valve body 31 to the second valve body 32 to form a valve body assembly 10.

Specifically, fixedly or limitedly connecting the first valve body 31 to the second valve body 32 to form the valve body assembly 10 includes the following steps:
mounting the first valve body 31 to the second valve body 32 in the radial direction of the valve apparatus 100, limiting a portion of the first housing 311 in a groove of a first recess 11, and limiting a portion of the first housing 311 in a groove of a second recess 21; and
fixing the first housing 311 to a first cover 1 by welding, and fixing the first housing 311 to a second cover 2 by welding.

In the above steps, the first valve body 31 is limited by the first recess 11 and the second recess 21 in the circumferential direction and the axial direction, so that the first valve body 31 will not be displaced relative to the second valve body 32 in the subsequent welding step.

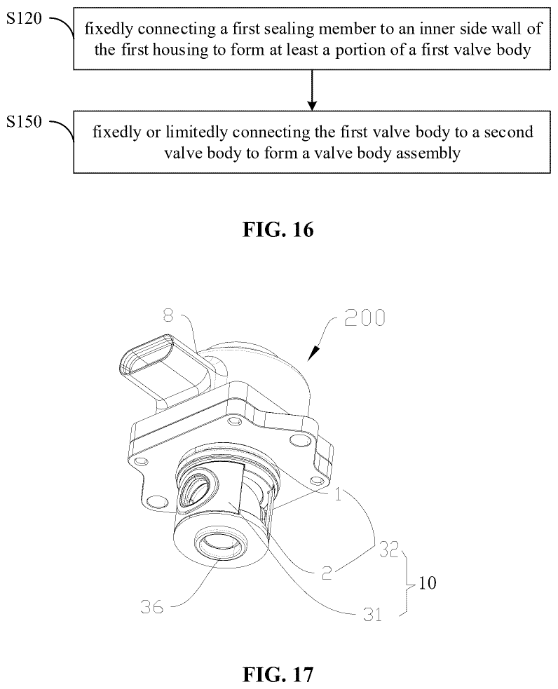

It should be noted that, as shown in FIG. 15, there is no order for steps S130, S140 and steps S110, S120, and these steps may be performed at the same time. In some embodiments, as shown in FIG. 16, the method for manufacturing the valve apparatus at least includes the following two steps: S120, fixedly connecting a first sealing member 52 to an inner side wall of a first housing 311 to form at least a portion of a first valve body 31; and S150, fixedly or limitedly connecting the first valve body 31 to a second valve body 32 to form a valve body assembly 10.

When the valve apparatus 100 is required to fulfill functions beyond three-way, the valve body assembly 10 may include two or more first valve bodies 31. Repeating step S150 may allow to fixedly connect the two or more first valve bodies 31 to the second valve body 32 to meet different functional requirements. Therefore, the valve apparatus 100 of the present application has the advantage of modularization, and the number of the first valve bodies 31 can be increased or decreased without changing the structures of the first cover 1 and the second cover 2 to form different communication structures. For example, one first valve body 31 is provided to correspondingly form a two-way structure, two first valve bodies 31 are provided to correspondingly form a three-way structure, or three first valve bodies 31 are provided to correspondingly form a four-way structure. The first valve bodies 31 may be spaced apart from each other in the circumferential direction of the valve apparatus 100, and specifically, the two or more first valve bodies 31 may be rotationally symmetrically distributed in a circumferential direction of the valve core 7, ensuring relatively uniform force applied on the valve core 7 in the radial direction.

As shown in FIG. 12 and FIG. 13, the communication assembly 6 includes first flow channels 61 and a second flow channel 62. As shown in FIG. 4 to FIG. 8, each of the first flow channels 61 is in communication with the first communication opening 314, and the second flow channel 62 is in communication with the third communication opening 36. Along the radial direction of the valve body assembly 10, the second sealing member 51 is located between a wall forming the mounting cavity 63 and the outer side wall 313, so that the wall forming the mounting cavity 63 and the outer side wall 313 press the second sealing member 51 to form sealing.

As shown in FIG. 1 to FIG. 4, in this embodiment, the valve body assembly 10 includes two first valve bodies 31. There is a gap between two ends of each of the first valve bodies 31 in the circumferential direction of the valve apparatus 100. The two adjacent first valve bodies 31 are separated by a distance, that is, a notch is formed between the two adjacent first valve bodies 31. Specifically, the valve body assembly 10 has a notch channel 301, which is formed between the two adjacent first valve bodies 31 in the circumferential direction of the valve apparatus 100. The notch channel 301 is in communication with the accommodation cavity 30 and runs through the valve body assembly 10 in the radial direction of the valve apparatus 100. Compared with the valve body assembly having a closed annular structure surrounding the valve core 7 in the related technology, in this embodiment, the valve body assembly 10 does not need to form a closed annular structure, so that each first valve body 31 may have a small circumferential size, thereby reducing the weight of the first valve body 31, further reducing the weight of the valve apparatus 100, and facilitating lightweight of the valve apparatus 100.

Along the axial direction of the valve apparatus 100, the driving part 8 is located on one side of the valve body assembly 10 and is fixedly or limitedly connected to one end of the valve body assembly 10, and the third communication opening 36 is located at the other end of the valve body assembly 10. The valve apparatus 100 includes a third sealing member 53, which surrounds the valve body assembly 10 in the circumferential direction of the valve apparatus 100. The third sealing member 53 is closer to the driving part 8 than the first communication opening 314 in the axial direction of the valve apparatus 100, and the third sealing member 53 is closer to the driving part 8 than the notch channel 301 in the axial direction of the valve apparatus 100. As a result, the third sealing member 53 plays a role in reducing the leakage of the valve apparatus 100.

Specifically, when the valve apparatus 100 has been mounted to the communication assembly 6, the third sealing member 53 is located between a wall forming the mounting cavity 63 and the outer periphery of the valve body assembly 10 in the radial direction of the valve body assembly 10, so that the wall forming the mounting cavity 63 and the valve body assembly 10 press against the third sealing member 53 to form sealing, which prevent fluid in the notch channel 301 and the third communication opening 36 from flowing out of the mounting cavity 63.

In this embodiment, there is no sealing member provided around the third communication opening 36. When the valve apparatus 100 is mounted to the communication assembly 6, the second sealing member 51 prevents the third communication opening 36 from being in fluid communication with the first communication opening 314 outside the valve apparatus 100, thereby ensuring that the third communication opening 36 can only be in communication with the first communication opening 314 through the communication channel 71 of the valve core 7. In addition, there is no sealing member provided around the notch channel 301. When the valve apparatus 100 has been mounted to the communication assembly 6, the second sealing member 51 prevents the notch channel 301 from being in fluid communication with the first communication opening 314 outside the valve apparatus 100. Even if the communication channel 71 of the valve core 7 is in communication with the notch channel 301, the fluid flowing into the mounting cavity 63 from the second flow channel 62 can only flow into the first flow channel 61 through the first communication opening 314. The unidirectional arrow in FIG. 12 shows a flow direction of the fluid in the integrated assembly, the third communication opening 36 serves as a fluid inlet, the first communication opening 314 serves as a fluid outlet, and the third communication opening 36 can be selectively in communication with one of the two first communication openings 314 through the rotation of the valve core 7.

Two end faces of the first housing 311 in the circumferential direction of the valve apparatus 100 are parallel to the axial direction of the valve apparatus 100, and two end faces of the first housing 311 in the axial direction of the valve apparatus 100 are parallel to the circumferential direction of the valve apparatus 100. The whole first housing 311 is rectangular in shape, and the notch channel 301 is rectangular in shape.

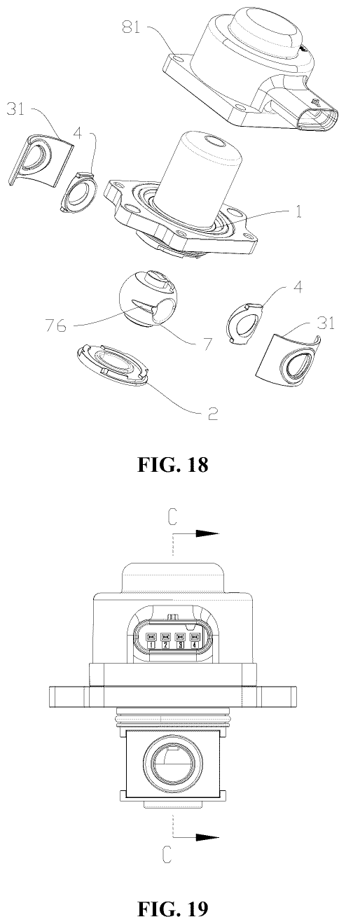

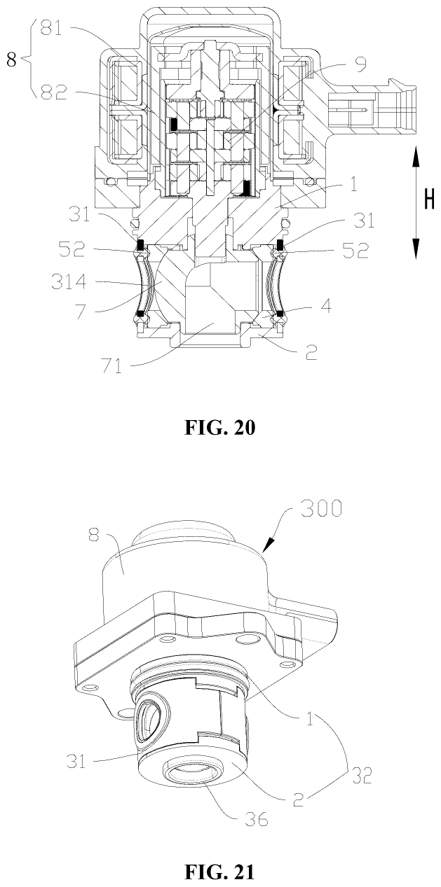

In some embodiments of the valve apparatus, for example in the valve apparatus 200 shown in FIG. 17 to FIG. 20, an outer peripheral surface of the valve core 7 is circular in shape, and a portion of the sealing seat 4 in sliding fit with the valve core 7 is also circular in shape. The valve core 7 in such shape makes the force applied on the sealing seat 4 more uniform. The valve apparatus 200 can be applied in a refrigerant system, and the valve core 7 has a throttling groove 76, which is located on an outer peripheral surface of the valve core 7. One end of the throttling groove 76 is in communication with the communication channel 71, and the throttling groove 76 can allow throttling and expansion of the refrigerant.

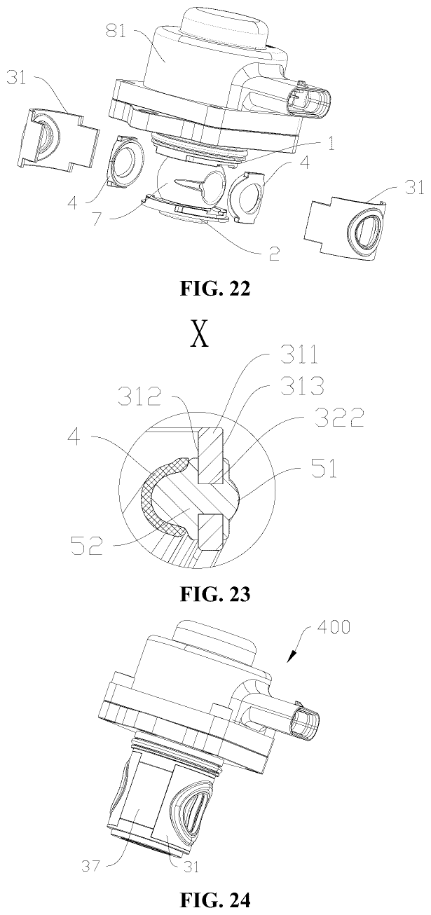

In some embodiments of the first valve body 31, for example in the valve apparatus 300 shown in FIG. 21 to FIG. 22, an orthographic projection of the first housing 311 on the first plane is semi-circular in shape. That is, in the circumferential direction of the valve apparatus 100, an included angle between two planes extending respectively through the two ends of the first housing 311 and intersecting at the central axis of the valve core 7 is equal to 180 degrees. Two circumferential ends of one of the first valve bodies 31 are fixed and hermetically connected to two circumferential ends of the other first valve body 31 by welding, and the two first valve bodies 31 are assembled to form a whole annular structure, which can increase the supporting strength and the torsional strength of the valve body assembly 10. In addition, the notch between the two first valve bodies 31 is partially closed, so that the cleanliness during the transportation process can be increased.

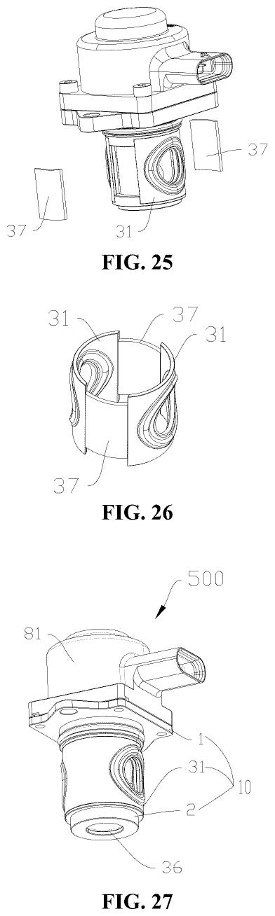

In another embodiment of the present application, for example in the valve apparatus 400 shown in FIG. 24 to FIG. 26, the valve body assembly 10 further includes third valve bodies 37 on the basis of the valve apparatus 100. The third valve bodies 37 are respectively located between two adjacent first valve bodies 31 in the circumferential direction of the valve apparatus 400. Two circumferential ends of each of the third valve body 37 are respectively fixed and hermetically connected to the two adjacent first valve bodies 31 by welding, that is, the third valve body 37 fills a portion of the notch, so that the two first valve bodies 31 and the two third valve bodies 37 are assembled and welded to form a whole annular structure, which can increase the supporting strength and the torsional strength of the valve body assembly 10.

In some embodiments of the present application, the sealing seat 4 is fixedly and hermetically connected to the first sealing member 52, thereby reducing the risk of leakage between the sealing seat 4 and the first sealing member 52. Specifically, as shown in FIG. 23, FIG. 23 is a schematic view corresponding to part X in FIG. 7 in another embodiment. The sealing seat 4 is in a form of a film or a sheet, and is made of a fluorine-containing plastic, PTFE (Polytetrafluoroethylene), PEEK (poly (ether-ether-ketone)) or the like. The sealing seat 4 can be fixed to the first sealing member 52 by a spraying process, so that the fixation between the sealing seat 4 and the first sealing member 52 is more firm, and the number of parts of the valve apparatus 100 can be reduced, thus reducing the product cost. When the valve apparatus 100 is assembled, the step of independently assembling the sealing seat 4 can be saved, and the displacement between the sealing seat 4 and the first sealing member 52 during assembly can also be avoided. In addition, the second valve body 32 does not need to be provided with a limiting structure (for example, the third recess 13 and the fourth recess 23) for the sealing seat 4, thereby simplifying the structure of the second valve body 32. In other embodiments, the sealing seat 4 may be fixed to the first sealing member 52 by a vulcanization process.

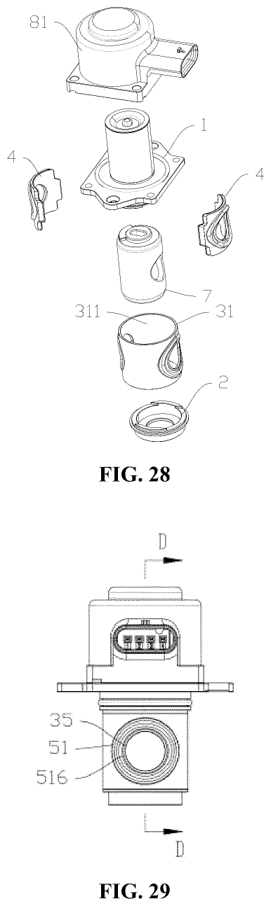

In some embodiments of the present application, as shown in FIG. 27 to FIG. 33, a valve apparatus 500 includes a valve body assembly 10, a valve core 7, a rotor assembly 82, a transmission assembly 9, and a stator assembly 81. At least a portion of the valve core 7 is located in the accommodation cavity 30 of the valve body assembly 10. The rotor assembly 82 is in transmission connection with the transmission assembly 9, and the valve core 7 is in transmission connection with the transmission assembly 9, so that the valve core 7 is driven by the transmission assembly 9 to rotate. The stator assembly 81 may be electrically and/or signally connected to the outside, and the stator assembly 81 includes a coil 811. At least a portion of the stator assembly 81 is located on the outer periphery of the rotor assembly 82, and the transmission assembly 9 is a planetary gear mechanism.

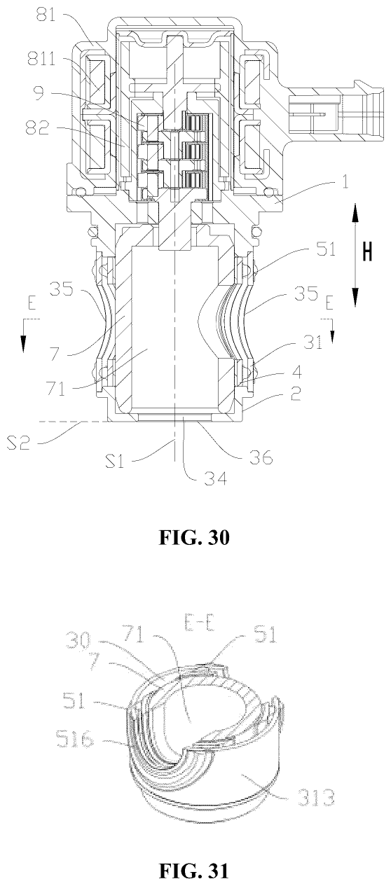

As shown in FIG. 30, an axial direction of the valve apparatus 500 is defined and indicated by H in the figure. A rotation axis of the valve core 7 is defined and is indicated by S1 in the figure, and the valve core 7 is rotatable around the rotation axis. The axial direction of the valve apparatus 500 is the same as an extension direction of the rotation axis of the valve core 7.

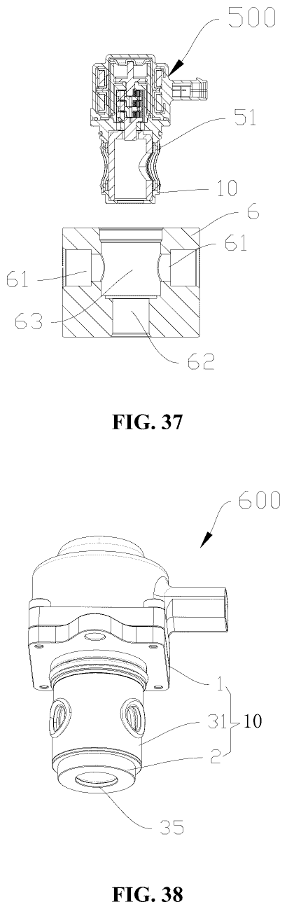

FIG. 36 and FIG. 37 show an integrated assembly including the above valve apparatus 500. The integrated assembly further includes a communication assembly 6, which may be plate-shaped or block-shaped, and only a portion of the communication assembly 6 is shown in the figure. The communication assembly 6 has a mounting cavity 63, and at least a portion of the valve body assembly 10 is located in the mounting cavity 63 when the valve apparatus 500 is mounted to the communication assembly 6. When assembling the integrated assembly, at least a portion of the valve body assembly 10 is inserted into the mounting cavity 63 along the axial direction of the valve apparatus 500.

As shown in FIG. 27 to FIG. 33, the valve body assembly 10 includes an outer side wall 313. The valve body assembly 10 has a first channel 33 with a second communication opening 35 on the outer side wall 313. The outer side wall 313 is arranged at an angle to a radial direction of the valve apparatus 500, so that the second communication opening 35 has a length in the axial direction of the valve apparatus 500. The valve apparatus 500 includes a second sealing member 51. As shown in FIG. 29 and FIG. 31, the second sealing member 51 has a third through-hole 516, which corresponds to and is in communication with the second communication opening 35, and the second sealing member 51 is fixedly connected to or integrated with the outer side wall 313. Further, at least a portion of the second sealing member 51 circumferentially surrounds the second communication opening 35, and the third through-hole 516 is not in communication with the third communication opening 36, so that the second sealing member 51 can prevent the third communication opening 36 from being in fluid communication with the second communication opening 35 outside the valve apparatus 500. Compared with a sealing structure provided with multiple O-rings extending in the circumferential direction of the valve apparatus in the related technology, this embodiment is improved to provide a sealing member in the circumferential direction of the communication opening, which can save raw materials, simplify the manufacturing process, and reduce the processing procedures and the cost. The second sealing member 51 is fixedly connected to the outer side wall 313 of the valve body assembly 10 to form a whole, which can reduce the number of parts of the valve apparatus 500, simplify the assembling steps of the valve apparatus 500 and improve the sealing effect. When the valve body assembly 10 is inserted into the communication assembly 6 along the axial direction of the valve apparatus 500, the second sealing member 51 can be prevented from being detached or displaced.

As shown in FIG. 30, FIG. 36 and FIG. 37, the communication assembly 6 includes first flow channels 61 and a second flow channel 62. Each of the first flow channels 61 is in communication with the second communication opening 35 through the third through-hole 516, and the second flow channel 62 is in communication with the third communication opening 36. Along the radial direction of the valve body assembly 10, the second sealing member 51 is located between a wall forming the mounting cavity 63 and the outer side wall 313, so that the wall forming the mounting cavity 63 and the outer side wall 313 press against the second sealing member 51 to form a seal.

In this embodiment, the second sealing member 51 is fixed to the outer side wall 313 by a vulcanization process. Specifically, the outer side wall 313 is made of a metal material, for example, stainless steel, and the second sealing member 51 is made of a rubber, for example, EPDM. Due to the high surface energy of the metal, the firmness degree after vulcanization can be improved, so that the second sealing member 51 can be firmly fixed to the outer side wall 313 of the valve body assembly 10, thereby reducing the risk of leakage. In other embodiments, the second sealing member 51 may be fixed to the outer side wall 313 by adhesive.

As shown in FIG. 27 to FIG. 33, in this embodiment, the outer side wall 313 is a curved surface. Specifically, the outer side wall 313 extends in the axial direction of the valve apparatus 500, and the outer side wall 313 of the valve body assembly 10 is cylindrical or quasi-cylindrical in shape, in which case the size of the valve body assembly 10 in the radial direction of the valve apparatus 500 can be reduced. Compared with a flat surface, the curved outer side wall 313 is more difficult to mount the sealing member, so that the second sealing member 51 is fixed to the outer side wall 313 by a vulcanization process, thereby reducing the risk of the second sealing member 51 detaching from the curved surface. A first plane is defined and is indicated by S2 in FIG. 30. The first plane is perpendicular to the axial direction of the valve apparatus 500, and coincides with one end of the valve body assembly 10 in the axial direction of the valve apparatus 500. An orthographic projection of the second sealing member 51 on the first plane is parallel to or substantially parallel to the outer side wall 313. Alternatively, the curvature of the second sealing member 51 conforms to the shape of the outer side wall 313. This arrangement can reduce the size of the second sealing member 51 in the radial direction of the valve apparatus 500, and in turn reduce the radial size of the mounting cavity 63, thereby facilitating the miniaturization of the valve apparatus 500 and the communication assembly 6. In this embodiment, the orthographic projection of the second sealing member 51 on the first plane is of an arc shape as a whole. In addition, in other embodiments, the outer side wall 313 of the valve body assembly 10 may be of conical, prismatic, pyramid, or other shapes, and any structure of the outer side wall 313 that allows for insertion will fall within the protection scope of the present application. It should be noted that “substantially parallel” means that an included angle between the two is less than 5 degrees.

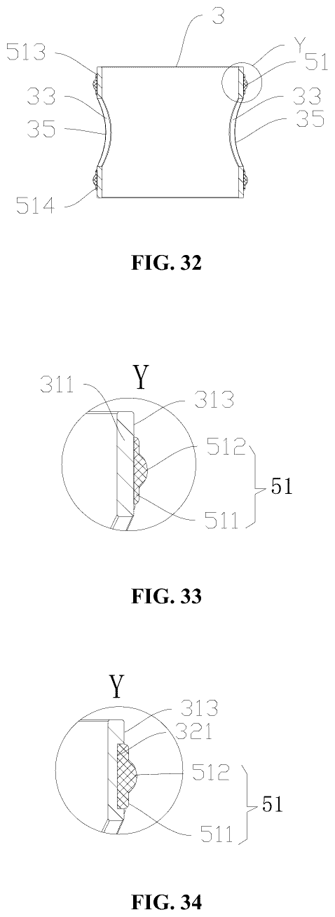

As shown in FIG. 32 and FIG. 33, the second sealing member 51 includes a connecting part 511 and a sealing part 512. The sealing part 512 is farther away from the outer side wall 313 than the connecting part 511 and is configured to be in contact with a wall forming the mounting cavity 63. The connecting part 511 is fixedly and hermetically connected to the outer side wall 313. The sealing part 512 extends in a direction away from the outer side wall 313 relative to the connecting part 511 and surrounds the third through-hole 516 along a circumferential direction of the third through-hole 516 to form a closed loop. In a cross-section of the second sealing member 51, the connecting part 511 has a length greater than that of the sealing part 512 in a direction parallel to the outer side wall 313, so that the area of the fixation between the second sealing member 51 and the outer side wall 313 is relatively large, and the firmness of the fixation between the second sealing member 51 and the outer side wall 313 can be improved, thereby reducing the risk of leakage between the second sealing member 51 and the outer side wall 313. The sealing part 512 has a relatively small length, so that the sealing part 512 is more easily compressed and deformed in the radial direction of the valve apparatus 500. In addition, after the valve apparatus 500 is inserted into the mounting cavity 63, the contact surface between the sealing part 512 and an inner wall forming the mounting cavity 63 is relatively small, and the pressure per unit area is relatively large, thus allowing a better sealing effect between the second sealing member 51 and the inner wall forming the mounting cavity 63. Specifically, the length of the connecting part 511 may be 1.5 or more times greater than that of the sealing part 512.

In the cross-section of the second sealing member 51, the length of the sealing part 512 in a direction parallel to the outer side wall 313 becomes smaller as it is farther away from the outer side wall 313, facilitating demolding during the manufacturing process of the second sealing member 51. Specifically, the sealing part 512 has an arc-shaped surface, so that the friction between the sealing part 512 and the inner wall forming the mounting cavity 63 is relatively small when mounting the second sealing member 51.

As shown in FIG. 27 to FIG. 33, the valve body assembly 10 includes a first cover 1, a second cover 2, and a first valve body 31. The outer side wall 313 is located outside the first valve body 31. Specifically, the first valve body 31 includes a first housing 311 and the second sealing member 51 described above. The first housing 311 is cylindrical, which reduces its volume and allows it to be processed and formed from a cylindrical pipe, resulting in a simple processing process. Along the axial direction of the valve apparatus 500, one end of the first valve body 31 is fixed and hermetically connected to the first cover 1 by welding, and the other end of the first valve body 31 is fixed and hermetically connected to the second cover 2 by welding, so that the strength of the fixing by welding is more secure, and the assembly space can be saved. The valve apparatus 500 further includes a sealing seat 4, which is located between an outer peripheral surface of the valve core 7 and the first valve body 31 in the radial direction of the valve apparatus 500. The outer peripheral surface of the valve core 7 is cylindrical or quasi-cylindrical in shape, and the sealing seat 4 is in sliding fit with the outer peripheral surface of the valve core 7.

In other embodiments, as shown in FIG. 34, FIG. 34 is a schematic view corresponding to part Y in FIG. 32 in another embodiment. The outer side wall 313 has a groove 321, which surrounds the first channel 33 along a circumferential direction of the first channel 33. At least a portion of the second sealing member 51 is located in the groove 321 and is fixedly connected to an inner wall forming the groove 321. In this way, the area of the fixation between the second sealing member 51 and the valve body assembly 10 can be increased, thereby reducing the risk of the second sealing member 51 detaching from the valve body assembly 10.

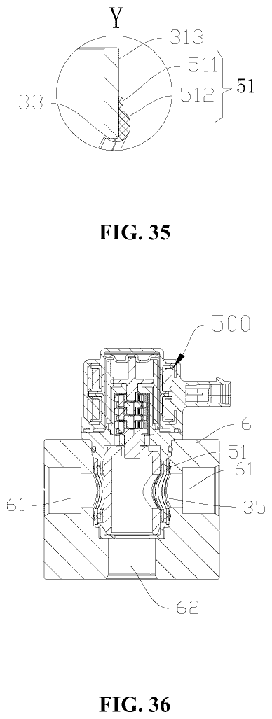

In other embodiments, as shown in FIG. 35, FIG. 35 is a schematic view corresponding to part Y in FIG. 32 in another embodiment. A portion of the second sealing member 51 is located in the first channel 33, and the second sealing member 51 is fixedly connected to an inner wall forming the first channel 33. In this way, the area of the fixation between the second sealing member 51 and the valve body assembly 10 can be increased, thereby reducing the risk of the second sealing member 51 detaching from the valve body assembly 10.

As shown in FIG. 30, along the axial direction of the valve apparatus 500, one end of the valve body assembly 10 is fixedly or limitedly connected to the stator assembly 81, and the third communication opening 36 is located on an end face of the other end of the valve body assembly 10, so that the axial size of the valve body assembly 10 can be reduced, and the flow resistance of the flow channel inside the valve apparatus 500 is small. The valve core 7 has a communication channel 71, which can be in communication with the third communication opening 36, and can be in communication with the second communication opening 35. In this embodiment, a portion of the communication channel 71 extends in the axial direction of the valve apparatus 500 and is in communication with the third communication opening 36, and the communication channel 71 can be in communication with the second communication opening 35 by rotating the control valve core 7 by a specific angle range.

A distance from the first plane S1 is defined as a height. The valve body assembly 10 may have two or more second communication openings 35, the communication channel 71 of the valve core 7 can be in communication with at least one of the second communication openings 35, and the heights of the second communication openings 35 are the same or at least partially the same, so that the size of the valve body assembly 10 in the axial direction of the valve apparatus 500 can be reduced. Correspondingly, the valve apparatus 500 may include two or more second sealing members 51, the number of the second sealing members 51 is the same as that of the second communication openings 35, and the second sealing members 51 are in one-to-one correspondence with the second communication openings 35.

As shown in FIG. 27 to FIG. 37, in this embodiment, the valve body assembly 10 has two second communication openings 35, the heights of which are the same or at least partially the same. In the radial direction of the valve apparatus 500, the two second communication openings 35 are located on two opposite sides of the outer side wall 313, and the two second sealing members 51 are also located on two sides of the outer side wall 313. Specifically, since the two second sealing members 51 are symmetrically arranged along one diameter of the valve body assembly 10, the forces applied on radial sides of the outer side wall 313 are uniform, which is beneficial to improving the coaxiality of the valve body assembly 10 and the mounting cavity 63. The communication channel 71 of the valve core 7 can be selectively in communication with at least one of the two second communication openings 35 through the rotation of the valve core 7.

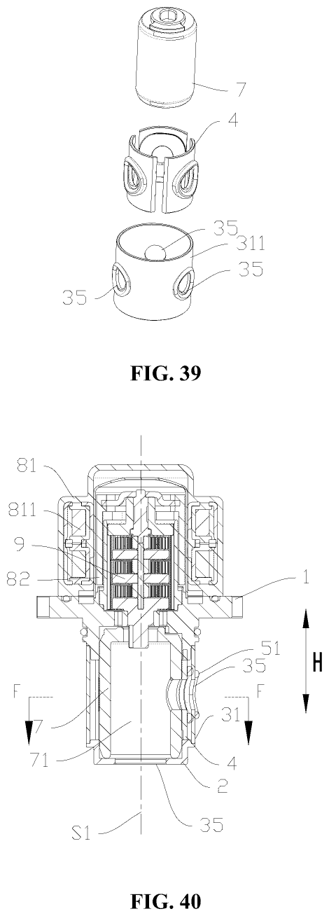

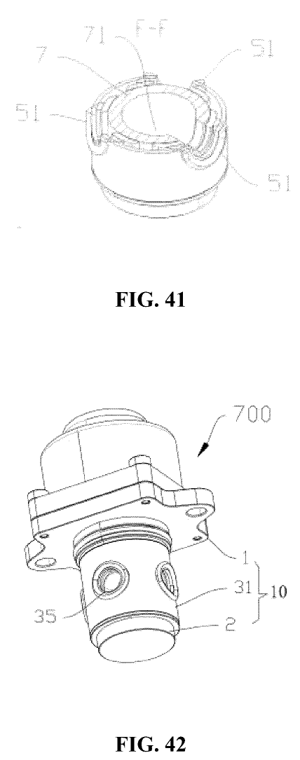

In another embodiment, as shown in FIG. 38 to FIG. 41, the valve body assembly 10 has three second communication openings 35, the heights of which are the same or at least partially the same. The third communication openings 36 are located at one end of the valve body assembly 10 in the axial direction of the valve apparatus 600, and the three second communication openings 35 and the three second sealing members 51 are rotationally symmetrically distributed in the circumferential direction of the valve apparatus 600 respectively. The communication channel 71 of the valve core 7 can be selectively in communication with at least one of the three second communication openings 35 through the valve core 7, so as to realize a function of one-inlet-into-three-outlet.

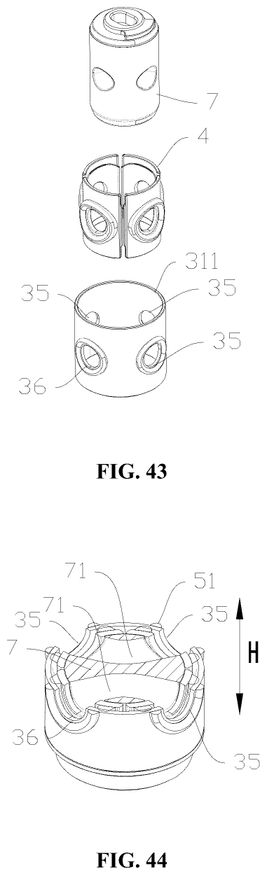

In another embodiment, for example in a valve apparatus 700 shown in FIG. 42 to FIG. 44, the valve body assembly 10 has three second communication openings 35. The three second communication openings 35 and the third communication opening 36 have the same or at least partially the same height. One of the second sealing members 51 corresponds to the third communication opening 36, and the three second communication openings 35 and the third communication opening 36 are rotationally symmetrically distributed in the circumferential direction of the valve apparatus 700. The valve core 7 has two communication channels 71, the heights of which are the same or at least partially the same. One of the communication channels 71 can be selectively in communication with at least two of the three second communication openings 35 and the third communication opening 36 to realize a four-way switching function.

In another embodiment, the number of the second sealing members 51 may be one less than the number of the second communication openings 35. One of the second communication openings 35 does not correspond to any one of the third through-holes 516, and the remaining second communication openings 35 are in one-to-one correspondence with the third through-holes 516 of the second sealing members 51. This is because after the remaining second communication openings 35 are sealed, this second communication opening 35 will not be in fluid communication with other second communication openings 35.

In some embodiments, as shown in FIG. 32, the second sealing member 51 includes a first end 513 and a second end 514 respectively located at two ends thereof in the axial direction of the valve apparatus 100. Along the radial direction of the valve apparatus 100, the first end 513, the second end 514 of the second sealing member 51 and the second communication opening 35 are located on the same side of the valve body assembly 10, so that the arrangement of the second sealing member 51 facilitates demolding of the second sealing member 51 from a radial side of the valve body assembly 10.

In some embodiments, as shown in FIG. 30, the second sealing members 51 are separately arranged. In other embodiments, at least two of the second sealing members 51 may be formed into an integrated structure, which is convenient for manufacturing. A shape of the third through-hole 516 of the second sealing member 51 includes, but is not limited to, circular, rectangular or oval shape and the like.

It should be noted that the above embodiments are merely used to illustrate the present application, but not to limit the technical solutions described in the present application. Although the present application has been described herein in detail with reference to the above embodiments, it should be understood that modifications or equivalent replacements to the present application can still be made by those skilled in the art, and all technical solutions and improvements thereto that do not apart from the spirit and scope of the present application should be covered by the scope of the claims of the present application.

1. A valve apparatus, comprising a valve body assembly and a valve core, wherein at least a portion of the valve core is located in an accommodation cavity of the valve body assembly, and the valve core has a communication channel;
the valve body assembly comprises a first housing;
the first housing comprises an inner side wall, at least a portion of the inner side wall faces the valve core, the valve apparatus comprises a first sealing member, which is fixedly connected to the inner side wall, the first housing has a first communication opening, at least a portion of the first sealing member surrounds the first communication opening, and the communication channel is allowed to be in communication with the first communication opening;
and/or, the first housing comprises an outer side wall, the valve apparatus comprises a second sealing member, which is fixedly connected to the outer side wall, the first housing has a second communication opening, at least a portion of the second sealing member surrounds the second communication opening, and the communication channel is allowed to be in communication with the second communication opening.

2. The valve apparatus according to claim 1, wherein the valve body assembly comprises a first valve body, the first valve body comprises the first housing and the first sealing member, there is a gap between two ends of the first valve body in a circumferential direction of the valve apparatus, and the valve body assembly comprises two or more first valve bodies, which are separately arranged and are spaced apart from each other in the circumferential direction of the valve apparatus.

3. The valve apparatus according to claim 2, wherein every two adjacent first valve bodies are separated by a distance in the circumferential direction of the valve apparatus, and the valve body assembly has a notch channel, wherein the notch channel is formed between the two adjacent first valve bodies in the circumferential direction of the valve apparatus, and the notch channel is in communication with the accommodation cavity.

4. The valve apparatus according to claim 3, wherein the valve apparatus comprises a driving part, which is fixedly or limitedly connected to one end of the valve body assembly in an axial direction of the valve apparatus;
the valve apparatus comprises a third sealing member, which surrounds the valve body assembly in the circumferential direction of the valve apparatus, wherein the third sealing member is closer to the driving part than the first communication opening in the axial direction of the valve apparatus, and the third sealing member is closer to the driving part than the notch channel in the axial direction of the valve apparatus.

5. The valve apparatus according to claim 2, wherein the valve body assembly comprises a second valve body, the first valve body and the second valve body are separately arranged, and the first valve body is fixedly or limitedly connected to the second valve body;
the second valve body comprises a first cover and a second cover, wherein in the axial direction of the valve apparatus, the first cover and the second cover are separated by a distance and are respectively located on two sides of the first housing, and at least a portion of the valve core is located between the first cover and the second cover;
in the axial direction of the valve apparatus, one end of the first housing is fixedly connected to the first cover, and the other end of the first housing is fixedly connected to the second cover; and
in the circumferential direction of the valve apparatus, an included angle between two planes extending respectively through two ends of the first housing and intersecting at a central axis of the valve core is less than or equal to 180 degrees.

6. The valve apparatus according to claim 1, wherein the first sealing member has a first through-hole, the first communication opening corresponds to the first through-hole and is in communication with the first through-hole, the first sealing member is formed and fixed to the first housing by a vulcanization process, and/or the first sealing member is fixed to the first housing by adhesive.

7. The valve apparatus according to claim 6, comprising a sealing seat, wherein at least a portion of the sealing seat is located between the first sealing member and an outer periphery of the valve core in a radial direction of the valve apparatus, one side of the sealing seat is in sliding fit with the outer periphery of the valve core, the other side of the sealing seat abuts against or is fixedly connected to the first sealing member, and the sealing seat has a through-hole, which is in communication with the first communication opening and is allowed to be in communication with the communication channel.

8. The valve apparatus according to claim 6, wherein in the radial direction of the valve apparatus, the inner side wall and the outer side wall are located on two opposite sides of the first housing, the second communication opening is in communication with the first communication opening, and the second communication opening is located on the outer side wall;
the first housing has a second through-hole, which has an opening on each of the inner side wall and the outer side wall of the first housing, and the first sealing member comprises a coupling part, which is located in the second through-hole, wherein one end of the coupling part is fixedly connected to or integrated with the second sealing member.

9. The valve apparatus according to claim 1, wherein the second sealing member comprises a connecting part and a sealing part, the connecting part is fixedly connected to the outer side wall, and the sealing part extends in a direction away from the outer side wall relative to the connecting part;
the second sealing member has a third through-hole, which corresponds to the second communication opening and is in communication with the second communication opening, and the sealing part surrounds the third through-hole in a circumferential direction of the third through-hole to form a closed loop;
in a cross section of the second sealing member, the connecting part has a length greater than that of the sealing part in a direction parallel to the outer side wall.

10. The valve apparatus according to claim 1, wherein the second sealing member is formed and is fixed to the outer side wall by a vulcanization process, or the second sealing member is fixed to the outer side wall by adhesive; and
the outer side wall is made of a metal material, and the second sealing member is made of a rubber material.

11. The valve apparatus according to claim 1, wherein the outer side wall extends in the axial direction of the valve apparatus, and the outer side wall is cylindrical or quasi-cylindrical in shape; and
a first plane is defined as being perpendicular to the axial direction of the valve apparatus and coinciding with one end of the valve body assembly in the axial direction of the valve apparatus, and an orthographic projection of the second sealing member on the first plane is parallel or substantially parallel to the outer side wall.

12. The valve apparatus according to claim 9, wherein
the outer side wall has a groove, and at least a portion of the second sealing member is located in the groove and is fixedly connected to an inner wall forming the groove;
or the valve body assembly has a first channel, wherein the first channel is in communication with the second communication opening, and at least a portion of the second sealing member is located in the first channel and is fixedly connected to an inner wall forming the first channel.

13. The valve apparatus according to claim 9, wherein
a first plane is defined as being perpendicular to the axial direction of the valve apparatus and coinciding with one end of the valve body assembly in the axial direction of the valve apparatus, and a distance from the first plane is defined as a height;
the valve body assembly has two or more second communication openings, the communication channel is allowed to be in communication with at least one of the second communication openings, heights of the second communication openings are the same or at least partially the same, and the valve apparatus comprises two or more second sealing members;
the number of the second sealing members is the same as the number of the second communication openings, and the second sealing members are in one-to-one correspondence with the second communication openings;
or the number of the second sealing members is one less than the number of the second communication openings, one of the second communication openings does not correspond to any one of the third through-holes, and the remaining second communication openings are in one-to-one correspondence with the third through holes of the first sealing members;
the second sealing members are separately arranged, or at least two of the second sealing members are formed into an integrated structure.

14. An integrated assembly, comprising a communication assembly and the valve apparatus according to any one of claims 1 to 13, wherein the communication assembly comprises a first flow channel, a second flow channel and a mounting cavity, at least a portion of the valve body assembly is located in the mounting cavity, the first flow channel is in communication with the second communication opening, and the second flow channel is in communication with the second communication opening;
the second sealing member is located between a wall forming the mounting cavity and the outer side wall in a radial direction of the valve body assembly, the wall forming the mounting cavity abuts against the second sealing member, and the outer side wall abuts against the second sealing member.

15. A method for manufacturing a valve apparatus, comprising the following steps:
fixedly connecting a first sealing member to an inner side wall of a first housing to form at least a portion of a first valve body; and
fixedly or limitedly connecting the first valve body to a second valve body to form a valve body assembly.

16. The method for manufacturing the valve apparatus according to claim 15, wherein fixedly or limitedly connecting the first valve body to the second valve body to form the valve body assembly comprises the following steps:
mounting the first valve body to the second valve body in a radial direction of the valve apparatus, limiting a portion of the first housing in a groove of a first recess, and limiting a portion of the first housing in a groove of a second recess; and
fixing the first housing to a first cover by welding, and fixing the first housing to a second cover by welding.

17. The method for manufacturing the valve apparatus according to claim 15, wherein fixing the first sealing member to the inner side wall of the first housing comprises the following steps:
coating an adhesive on at least a portion of the inner sidewall;
placing at least a portion of the first housing-into an inner cavity of a mold, and then injecting a sealing member solution into the inner cavity of the mold; and
heating and pressurizing the sealing member solution and the first housing, so that the first sealing member is vulcanized and formed, and the first sealing member is fixedly connected to the inner side wall.
